(19) United States
(12) Patent Application Publication
(10) Pub. No.: US 2022/0092398 A1
(43) Pub. Date: Mar. 24, 2022

(54) Method and Apparatus for Offloading Tasks to Accelerator for Enhancing System Performance Using Configurable Devices

(71) Applicant: GOWIN Semiconductor Corporation, GuangZhou (CN)

(72) Inventor: Grant Thomas Jennings, Austin, TX (US)

(73) Assignee: GOWIN Semiconductor Corporation, GuangZhou (CN)

(21) Appl. No.: 17/478,901

(22) Filed: Sep. 18, 2021

Related U.S. Application Data
(60) Provisional application No. 63/080,706, filed on Sep. 19, 2020.

(51) Int. Cl. G06N 3/063; G06N 3/04; G06N 3/08

(52) U.S. Cl. CPC G06N 3/063; G06N 3/08; G06N 3/04

(57) ABSTRACT

A method and/or apparatus using programmable device for parallel processing logic operations is disclosed. The apparatus, such as a semiconductor integrated circuit die, includes an input memory, a processing unit, and an accelerator. The input memory is used to buffer input signals from an external component. The processing unit, such as a microcontroller, retrieves the input signals from the input memory and generates pre-processed data in accordance with the input signals. The first configured circuit containing configurable logic blocks (“LBs”) of a field programmable logic array (“FPGA”), in one embodiment, is programmed as an accelerator to perform one or more neural networking functions. For example, the accelerator is able to process a set of convolutional operation in response to at least a portion of the pre-processed data offloaded from the processing unit for identifying a result or reference.

### PRIORITY

This application claims the benefit of priority based upon U.S. Provisional Patent Application Ser. No. 63/080,706, filed on Sep. 19, 2020 in the name of the same inventor and entitled “Method and Apparatus for Offloading Computational Tasks to Enhance System Performance Using Configurable Devices,” the disclosure of which is hereby incorporated into the present application by reference.

### FIELD

The exemplary embodiment(s) of the present invention relates to the field of artificial intelligence, machine learning, and neural networks using semiconductor devices. More specifically, the exemplary embodiment(s) of the present invention relates to offload or redistribute tasks to devices and/or a field-programmable gate array (“FPGA”).

### BACKGROUND

With increasing popularity of digital communication, artificial intelligence (AI), machine learning, neural networks, IoT (Internet of Things), and/or robotic controls, the demand for faster and efficient hardware and semiconductors with processing capabilities is constantly in demand. To meet such demand, high-speed and flexible semiconductor chips are generally more desirable. Once conventional approach to satisfy such demand is to use dedicated custom integrated circuits and/or application-specific integrated circuits (“ASICs”) to fulfil such needs. A shortcoming with ASIC approach is that it lacks flexibility while consumes the large amount of resource.

AI typically is a simulation of human intelligence implemented by machines and/or computers. Specific applications of AI include expert systems, natural language processing (NLP), speech recognition, and machine vision. A subset of AI is machine learning (“ML”) which can be defined as a study of computer algorithms that improve automatically through experience. ML models generally employ neural networks imitating a process of human brain. Neural networks are a set of algorithms, modeled loosely after the human brain, that are designed to recognize patterns. Neural networks essentially interpret sensory data through a kind of machine perception, labeling or clustering raw input.

A conventional approach to handle AI, ML, or neural network operations uses dedicated custom integrated circuits and/or application-specific integrated circuits (“ASICs”). A shortcoming with ASIC approach is that this approach is generally expensive and limited flexibility. An alternative approach, which enjoys growing popularity, is utilizing programmable semiconductor devices (“PSD”) such as programmable logic devices (“PLDs”) or field programmable gate arrays (“FPGAs”). For instance, an end user can program a PSD to perform desirable AI or ML functions.

### SUMMARY

A configurable offloading system (“COS”) containing programmable semiconductor device such as a field programmable logic array (“FPGA”) is configured to provide parallel processing of logic operations for neural network operations. The system, such as fabricated in a semiconductor integrated circuit die, includes an input memory, a processing unit, and an accelerator. The input memory is used to buffer input signals from an external component. The processing unit, such as a microcontroller, retrieves the input signals from the input memory and generates pre-processed data in accordance with the input signals. The first configured circuit containing configurable logic blocks (“LBs”) of FPGA is programmed to operate as an accelerator for performing one or more neural network functions. For example, the accelerator is able to process a set of convolutional operation in response to at least a portion of the pre-processed data offloaded from the processing unit.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a configurable offloading system (“COS”) capable of offloading computational tasks to one or more accelerators in accordance with one embodiment of the present invention;

FIGS. 2A-2B are block diagrams illustrating an FPGA programmed to be a COS for handling one or more neural networking functions in accordance with one embodiment of the present invention;

FIG. 3 is a block diagram illustrating a software architecture of implementing neural network in FPGA in accordance with one embodiment of the present invention;

FIG. 4 is a logic block diagram illustrating a logic flow of COS operated in FPGA in accordance with one embodiment of the present invention;

FIG. 5 is a logic block diagram illustrating a logic flow of an accelerator within a COS environment in accordance with one embodiment of the present invention;

FIG. 6 is a block diagram illustrating a memory operation for facilitating data flow of COS for implementing neural network in accordance with one embodiment of the present invention;

FIG. 7 is a block diagram illustrating a memory controller of COS facilitating data buffering for implementing neural network in accordance with one embodiment of the present invention;

FIGS. 8-9 are diagrams illustrating an FPGA capable of facilitating COS for handling neural network operations in accordance with one embodiment of the present invention;

FIG. 10 is a flowchart illustrating a process of COS using FPGA in accordance with one embodiment of the present invention; and

FIGS. 11-12 are diagrams illustrating a digital processing system and a cloud-based system environment using one or more COSs in accordance with one embodiment of the present invention.

### DETAILED DESCRIPTION

Embodiments of the present invention disclose a method(s) and/or apparatus for providing a programmable semiconductor device (“PSD”) capable of providing artificial intelligence (“AI”) management.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general-purpose machines. In addition, those of ordinary skills in the art will recognize that devices of a less general-purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device, such as, but not limited to, magnetoresistive random access memory (“MRAM”), phase-change memory, or ferroelectric RAM (“FeRAM”), flash memory, ROM (Read Only Memory), PROM (Programmable Read Only Memory), EEPROM (Electrically Erasable Programmable Read Only Memory), Jump Drive, magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

In one embodiment, a system or a semiconductor apparatus containing programmable device such as an FPGA is configured to provide parallel processing of logic operations for neural network operations. The system, which can be a semiconductor integrated circuit (“IC”) die or an IC module, includes an input memory, a processing unit, and an accelerator. The input memory is used to buffer input signals from an external component. The processing unit, such as a microcontroller, retrieves the input signals from the input memory and generates pre-processed data in accordance with the input signals. The first configured circuit containing configurable logic blocks (“LBs”) of FPGA is programmed to operate as an accelerator for performing one or more neural networking functions. For example, the accelerator is able to process a set of convolutional operation in response to at least a portion of the pre-processed data offloaded from the processing unit for identifying references.

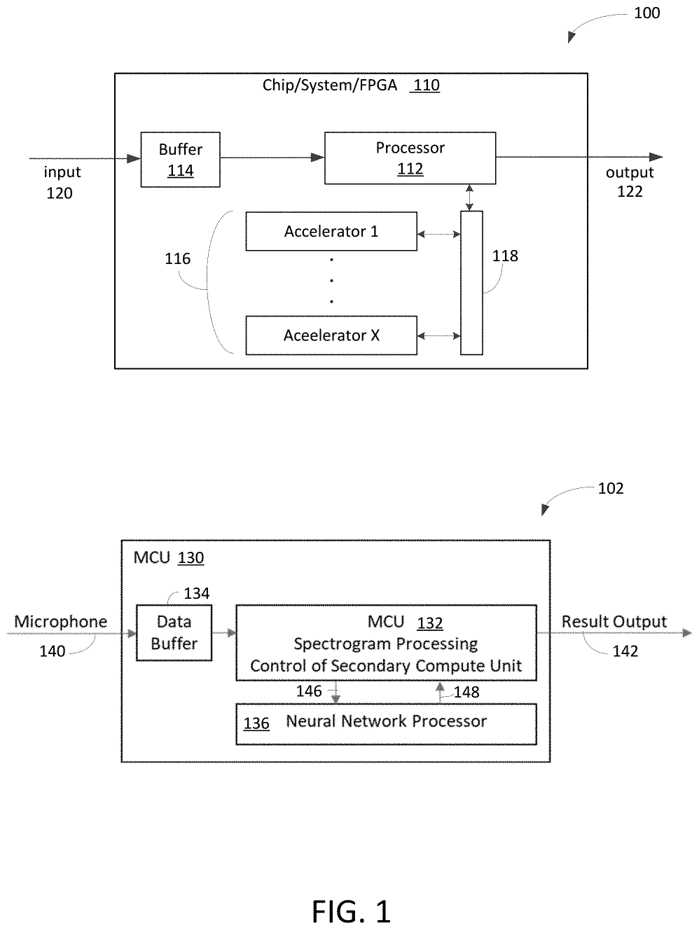

FIG. 1 is two block diagrams 100-102 illustrating a configurable offloading system (“COS”) capable of offloading computational tasks to one or more accelerators in accordance with one embodiment of the present invention. Diagram 100 includes input 120, output 122, and COS 110 wherein COS 110 can be implemented in a chip, IC, FPGA, semiconductor die, module, and/or system. In one example, COS 110 is coupled to one or more memory devices for facilitating neural network computations. It should be noted that the underlying concept of the exemplary embodiment(s) of the present invention would not change if one or more blocks (circuit or elements) were added to or removed from diagram 100.

COS 110 includes a buffer 114, processor 112, bus 118, and one or more accelerators. A function of COS 110 is to process AI related information. For example, when a sensor such as a microphone captures a sound, the sensor converts the sound into a stream of input signals such as input 120 and sends input 120 to COS 110. Buffer 114 is used to temporarily store or buffer input 120 to reduce signal or packet drop. After preliminary data processing, the input signals such as input 120 is pre-processed and/or converted by processor 112.

Processor 112 can be a hardcore microcontroller (“MCU”) or softcore MCU. A hardcore MCU is referred to as a block of die dedicated to embed a processor or MCU. A softcore MCU is referred to as a block of FPGA LBs programmed as an MCU to perform various MCU functions. For example, Ann Cortex-M™ processor can be embedded in an FPGA to perform MCU functions. Upon retrieving input signals from buffer 114, processor 112 preliminary processes the input signals and convert input signals to, for example, a spectrogram representing sound or music. The conversion of spectrogram, in one example, is a pre-processed data. A neural networking operation may be required to identify type of sound or music.

A spectrogram, in one example, can be a visual representation of the spectrum of frequencies representing a signal varies over time. For an audio signal, spectrograms can also be sonographs, voiceprints, or voicegrams. For data representing a 3D plot, spectrograms can also be referred to as waterfalls. For image or optics, a spectrogram provides an optical spectrometer. Spectrograms are used in the fields of heat, music, linguistics, sonar, radar, sound, seismology, images, pressure, and the like.

Accelerator or accelerators 116, also known as ML processors, are configured to specialize a set of specific tasks or neural network operations. In one embodiment, an FPGA is programmed to contain an accelerator. Depending on the applications, one or more accelerators can be embedded or configured in an FPGA. A function of accelerator 116 is to perform neural network operations which are offloaded from processor 112. For example, processor 112 offloads the spectrogram to accelerator 116 via bus 118. While accelerator 116 processes neural network operations in view of spectrogram, processor 112 can retrieve and pre-process the next input signals.

Diagram 102 illustrates MCU 130 that contains data buffer 134, MCU block 132, and neural network processor 136. After receiving signals 140 from a microphone, data buffer 134 temporarily holds signals 140 for avoiding data loss via packets drop. After pre-processing of converting signals to spectrogram, the spectrogram is offloaded to neural network process 136 as indicated by numeral 146. Upon identifying the result based on ML models and coefficients, result 142 is outputted as indicated by numeral 148.

Neural networks, in one example, can take significant computing power consuming the majority of CPU resources in a system. To improve throughput, a separate compute unit such as accelerator 116 is designed to offload the intensive compute functions of the neural network. Employing accelerator or ML processor should provide a better and more efficient method for computing application specific functions related to machine learning/neural networks while main processor or central processing unit (“CPU”) can continue other processing and/or control efforts.

In a case of using neural networks for phrase detection, audio data is often first converted from time/amplitude-based data to a spectrogram. The spectrogram is then used as the input to the neural network. For a traditional sequential process, first CPU/MCU computes the spectrogram and then CPU/MCU processes the neural network. The sequential process without substantially buffering, CPU/MCU generally does not have sufficient capacity to process both spectrogram and neural network in real-time whereby such system is likely drop data or packets.

To improve overall performance, MCU such as MCU 130 is able to offload the neural network to a separate compute unit such as neural network processor 136 to process the neural network while maintaining MCU (or CPU/MCU) to process the next set of audio spectrogram data in parallel. Employing accelerator 116 or 136 allows COS 110 or 130 to process a continual audio stream of data in real-time.

In one aspect, COS embedded in a semiconductor device contains FPGA which can be programmed to include accelerator(s) for implementing neural network operations. COS includes an input memory such as buffer 114 or 134, a processing unit 112 or 132, and a first programmed circuit such as accelerator 116 or 136. The input memory is used to buffer a stream of input signals such as 120 or 140 from an external component before being processed. In one aspect, the input memory is a group of memory cells onboard of FPGA. The external component is one of an optical sensor and microphone.

The processing unit or MCU retrieves the stream of input signals from the input memory and subsequently generates pre-processed data (i.e., spectrogram) in accordance with the stream of input signals. The processing unit can either be a hardcore processor fabricated on FPGA or a softcore processor programmed within configurable LBs in FPGA. Note that spectrogram can contain audio or video information.

The first circuit is embedded in FPGA containing configurable LB and programmed to be an accelerator for performing one or more neural networking functions. A function of accelerator or ML processor is capable of processing convolutional operations in response to the pre-processed data offloaded from the processing unit. For example, the first circuit is configured to be a visual accelerator capable of generating visual reference based on spectrogram containing visual images.

COS, in one embodiment, further includes a second circuit as configured to be a second accelerator programmed to perform one or more neural networking functions. For example, the second circuit is an audio accelerator configured to generate audio reference based on spectrogram containing sound.

An advantage of using COS is to improve processing speed of neural network operations via programmable accelerators.

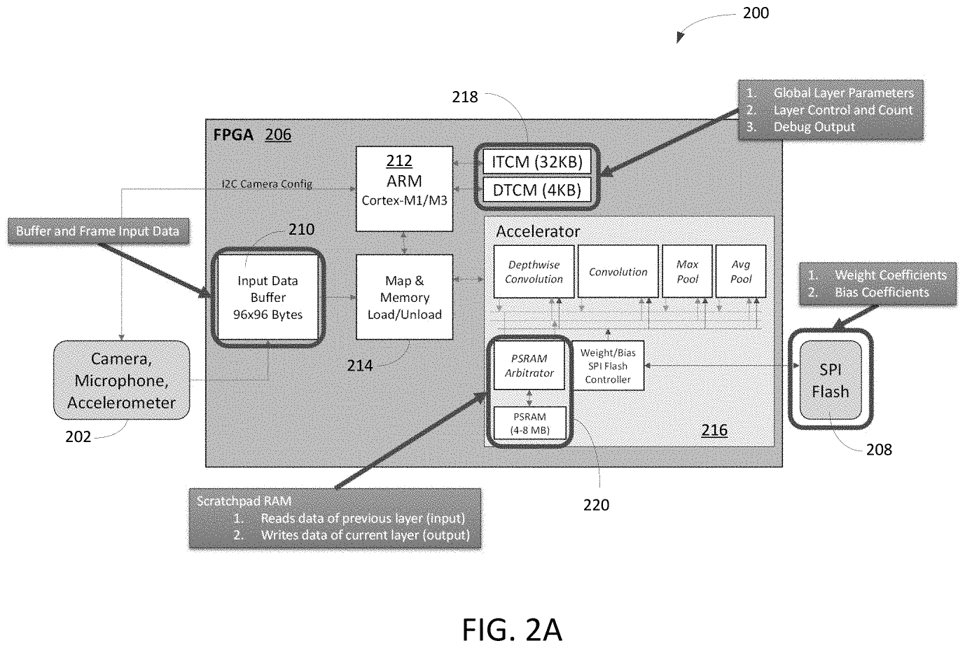

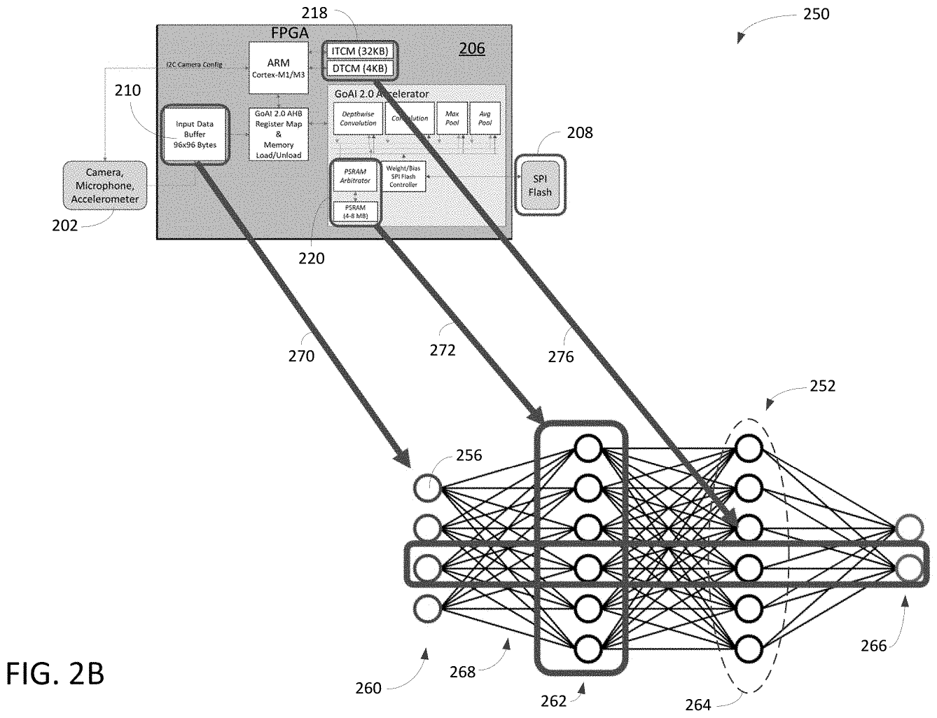

FIG. 2 is a block diagram 200 illustrating an FPGA programmed to be a COS for handling one or more neural networking functions in accordance with one embodiment of the present invention. Diagram 200 includes a sensor 202, FPGA 206, and SPI (serial peripheral interface) flash 208. In one aspect, FPGA 206 is configured to be COS. It should be noted that the underlying concept of the exemplary embodiment(s) of the present invention would not change if one or more blocks (circuit or elements) were added to or removed from diagram 200.

FPGA 206 is an exemplary programmable semiconductor device (“PSD”) including blocks or regions of configurable LBs. In one aspect, FPGA 206 includes input data buffer 210, processor 212, memory 214, tightly-coupled memory (“TCM”) 218, and accelerator 216. In one example, accelerator 216 further includes depthwise convolution block, convolution block, maximum pool block, average pool block, SPI flash controller, a pseudo static random-access memory (“PSRAM”) block 220. PSRAM block 220 includes an arbitrator and PSRAM. PSRAM, in one example, includes a DRAM macro block with an on-chip refresh circuit.

TCM 218 includes an instruction TCM (“ITCM”) and data TCM (“DTCM”) wherein ITCM handles instruction while DTCM stores data. TCM 218 includes RAM like memory usually storing frequently accessed data. While PSRAM includes DRAM storage with refresh circuit, SPI slash 208 is flash memory capable of being accessed by SPI.

Buffer 210 is used to buffer and frame input data. TCM 218 is configured to determine global layer parameters, layer control and count, and debug output. SPI flash 208 is used for storing weight coefficients and bias coefficients. PSRAM block 220 reads data from previous layer as input data and writes data of current layer as output. In one embodiment, FPGA 206 is capable of processing neural network operations using accelerator to process offloaded tasks from processor 212.

FIG. 2B is a block diagram 250 illustrating an FPGA programmed to be a COS for handling one or more neural networking functions in accordance with one embodiment of the present invention. Diagram 250, which is similar to diagram 200, except that diagram 250 includes a neural network 252. Diagram 250 shows an illustration of how an FPGA shown in diagram 200 applies to neural network 252. It should be noted that the underlying concept of the exemplary embodiment(s) of the present invention would not change if one or more blocks (circuit or elements) were added to or removed from diagram 200.

Neural network 252 includes four layers 260-266 wherein each layer includes multiple neurons 256. Neurons 256 at each layer uses connections 268, also known as synapses, to connect to other neurons 256 at different layers. It should be note that additional layers or hidden layers may be added to neural network 252.

In one embodiment, PSRAM size can be configured to determine the layer width that can be achieved as indicated by arrow 272. TCM (or MCU memory) 218 can be used to determine number of layers that can be achieved as indicated by arrow 276. Input data buffer 210 can be configured to determine the number of inputs that can be achieved as indicated by arrow 270.

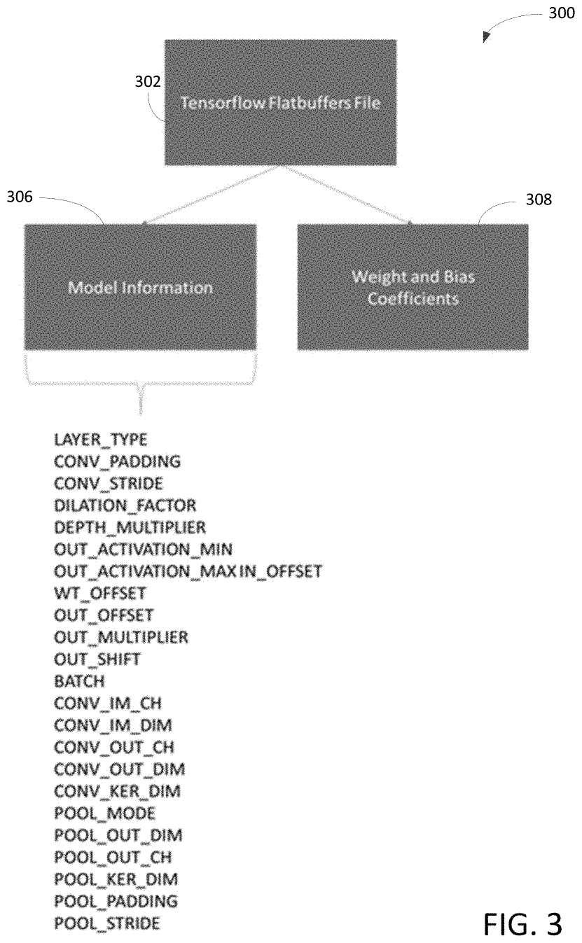

FIG. 3 is a block diagram 300 illustrating a software architecture of implementing neural network in FPGA in accordance with one embodiment of the present invention. Diagram 300 includes a block of Tensorflow™ Flatbuffers™ file or flatbuffers file 302, model information block 306, and coefficients block 308. In one aspect, FPGA can be programmed to be COS implementing neural network operations or ML processing in accordance with the information in flatbuffers file 302. It should be noted that the underlying concept of the exemplary embodiment(s) of the present invention would not change if one or more blocks (circuit or elements) were added to or removed from diagram 300.

Tensorflow is a machine learning software development platform including a software development suite called “Tensorflow Lite” and “Tensorflow lite for microcontrollers.” A function of Tensorflow is to optimize and quantize a trained machine learning model and subsequently generate C code used to deploy the trained model on a microcontroller. The trained model file from tensorflow is called a “flatbuffers” file or “*.tflite” file.

To use flatbuffers file for a machine learning processor or dedicated neural network architecture in an FPGA, a software script, for example, is used to strip or extract the information from the flatbuffers file. The model information as well as coefficients representing layer weights and bias are extracted. The model information such as “layer_type” and “cony-padding” is stored in model information block 306. Coefficients are stored in coefficients block 308. Both model information and coefficients can late be used to load into any custom machine learning processing unit or accelerator(s).

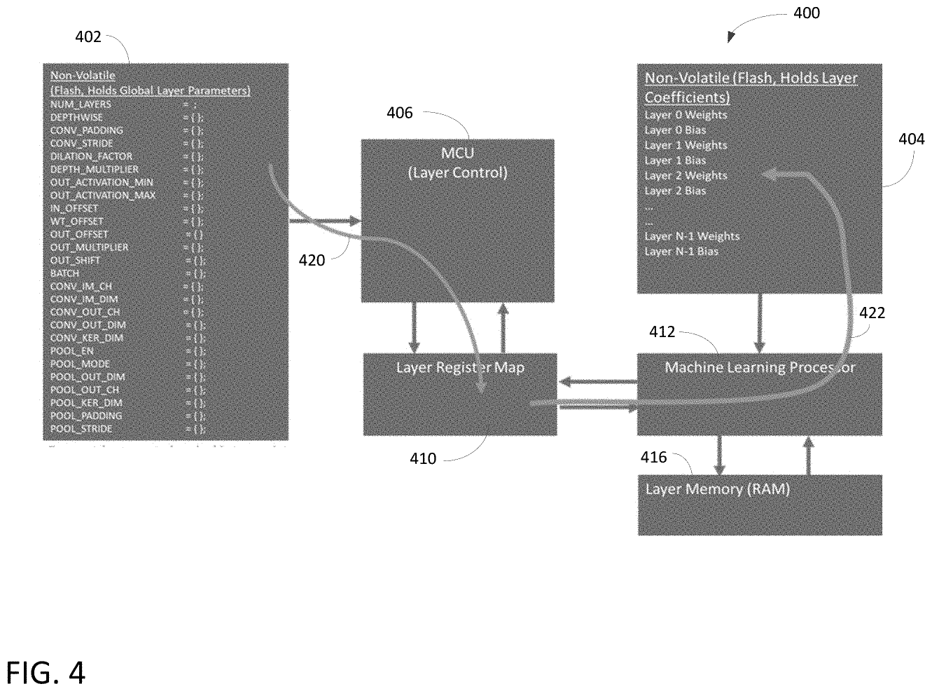

FIG. 4 is a logic block diagram 400 illustrating a logic flow of COS operated in FPGA in accordance with one embodiment of the present invention. Diagram 400 includes an MCU 406, layer register map 410, and ML processor 412. Diagram 400 further includes a first memory 402 configured to store model information and a second memory 404 used to store coefficients. Note that first and/or second memories 402-404 can be either volatile or non-volatile memories. It should be noted that the underlying concept of the exemplary embodiment(s) of the present invention would not change if one or more blocks (circuit or elements) were added to or removed from diagram 400.

Information and its coefficients from flatbuffers file can be parsed and subsequently stored in a flash memory of embedded hardware platform. The parameters from each layer can be stored as an array. An Extern or equivalent array can be used to allow updates of the parameters for each layer without recompiling the code. A control loop in the code can load layer parameters as well as a pointer to what coefficients should be used. The control loop can start the processing unit and monitor a register or interrupt to know when the layer processing is completed. Upon loading parameters for the next layer, the process starts again.

The architecture is created such that a user/developer does not need to write any code such as C/C++ or RTL/Verilog/VHDL to target the embedded hardware platform since the extern variables control the same set of code which operates in the MCU. MCU file, in one example, contains layer parameters and coefficient file contains coefficients for each layer. A FPGA bitstream contains pregenerated design with MCU, Machine learning processor, register map and sensor interface.

In operation, MCU 406 loads current layer parameters form first memory 402 to register map 410 as indicated by arrow 420. MCU 406 offloads neural network operations to ML processor and instructs ML processor to start execution. The layer is processed using coefficients in second memory 404 based on an offset in register map 410 for the current layer as indicated by arrow 422.

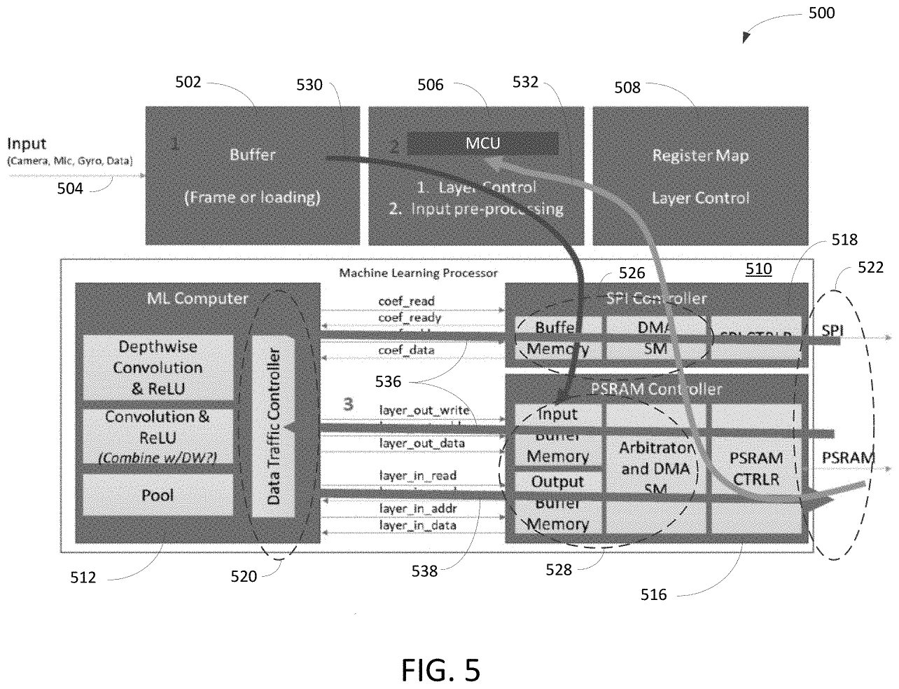

FIG. 5 is a logic block diagram 500 illustrating a logic flow of an accelerator within a COS environment in connection to memory allocations in accordance with one embodiment of the present invention. Diagram 500 includes a buffer 502, MCU 506, register map 508, and ML processor or accelerator 510. Buffer 502 receives input 504 and temporarily buffers the input frames from input 504. In one example, input 504 can be generated by a camera, microphone, gyroscope, or data from other devices. It should be noted that the underlying concept of the exemplary embodiment(s) of the present invention would not change if one or more blocks (circuit or elements) were added to or removed from diagram 500.

For machine learning, convolution and pooling algorithms consume a significant amount of memory and throughput. To facilitate COS neural network operations having an improved throughput, a state machine can be used to handle and initiate simultaneously data reads from coefficient ROM and input data RAM. In one embodiment, data traffic controller 520 of ML processor 510 is configured to perform functions of a state machine.

For example, data traffic controller 520 manages reads and handles wait times for neural network operations to optimize performance of memory interfaces whereby the need of continually update is reduced. It should be noted that neural network operations include, but not limited to, machine learning algorithms, convolution algorithms, and/or pooling algorithms. In one aspect, allocations of independent buffer memories and DMAs in COS can be controlled and adjusted based on the tradeoffs between availability of internal buffer memory and system throughput.

ML processor 510, in one embodiment, an SPI controller 518, PSRAM controller 516, and ML computer 512. ML computer 512 includes data traffic controller 520, depthwise convolution blocks, and pool block(s). SPI controller 518 includes buffer memory DMA, and SPI controller. PSRAM controller 516 includes an input buffer, output buffer, arbitrator, and PSRAM controller. In one embodiment, the buffer memories are configured to be increased or decreased in sizes depending on the applications as indicated in numerals 526-528. The selection of types of FPGA to implement COS determines a trade-off between the mount of memory used versus the overall performance of COS. It should be noted that ML processor 510 or accelerator with dedicated memories for coefficient ROM and layer RAM can deliver better COS throughput than the shared memory with other blocks.

In the operation of offloading from a microprocessor such as MCU 506 to a coprocessor such as ML processor 510, incoming data first runs into data buffer 502 which provides a means of holding sensor data while the processor such as MCU 506 or ML processor 510 is handing other system functions. MCU 506, which can be a system processor such as Cortex-M, subsequently loads input sensor data into ML processor 510 as indicated by arrow 530 through DMA or register map control to the layer RAM as shown PSRAM 522. Each layer in the neural network model is configured by the system processor and computed by ML processor 510 one at a time. Layer data is passed back and forth between ML computer 512 and the layer RAM 526-528 from within ML processor 510. Note that the neural network operation or tasks do not leave ML processor 510 unless for debugging purpose. SPI controller 518 is a ROM controller capable of holding layer coefficients for each of the filters within the neural network. Layer data, for example, can be read from the layer RAM within ML processor 510 to the system processor such as MCU 506 as indicated by numeral 532 through its memory map for the final layer of a Neural Network model to determine the result. It should be noted that the process starts over again to perform detection/inference on another set of data.

An advantage of using COS offloading scheme is that the system processor such as MCU 506 can offload a large number of tasks to an accelerator whereby it can handle other computing efforts in this system while the accelerator or ML processor 510 handles the machine learning processing.

COS, in one embodiment, uses one or more accelerators or ML processors 510 to co-process or parallel process neural network operations. During a real-time embedded applications, pre-processing of sensor data requires to be performed initially in order to have the pre-processed data ready for offloading to ML processor. For example, MCU 506 performs pre-processing for the next set of data to be processed while the current set of data is being processed in ML processor 510.

An advantage of using COS offloading scheme is to provide parallel processing using a programmable ML processor(s) to improve overall system performance.

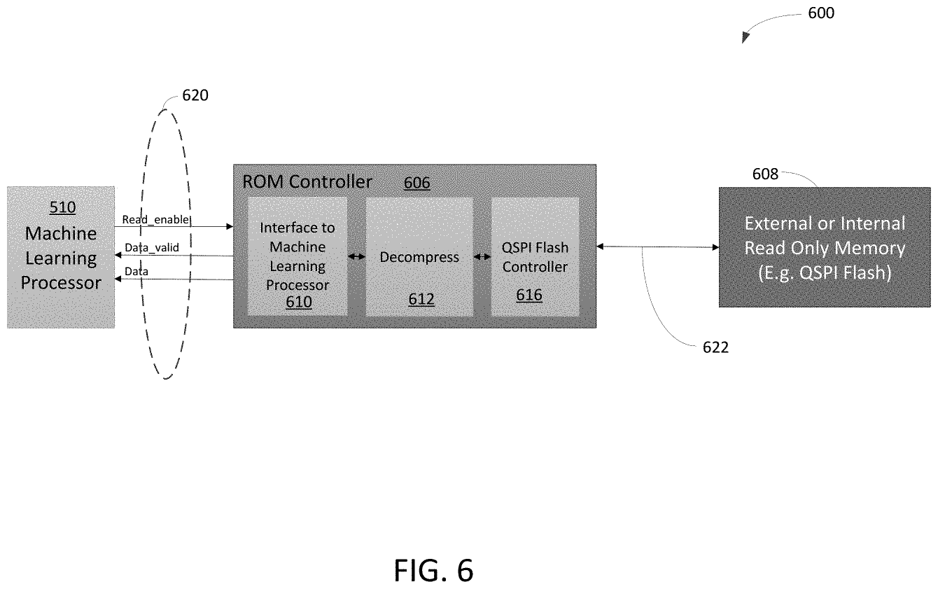

FIG. 6 is a block diagram 600 illustrating a memory operation for facilitating data flow of COS for implementing neural network in accordance with one embodiment of the present invention. Diagram 600 includes an ML processor 602, controller 606, and ROM 608. It should be noted that ROM 608 can either be external or internal memory. In one aspect, ROM can be implemented by flash or QSPI flash. It should be noted that the underlying concept of the exemplary embodiment(s) of the present invention would not change if one or more blocks (circuit or elements) were added to or removed from diagram 600.

Diagram 600 shows an exemplarily illustration of memory control architecture in accordance with coefficient for implementing COS operations. Coefficients are unique values used by each neural network layer. For example, in a convolutional neural network, the input layer data is multiplied and added by these coefficients to determine the output layer. These coefficients are calculated when the neural network is trained. After training, the model can use such coefficients to extract and detect certain attributes of the input.

Coefficients on a pre-trained model are static and can be stored in ROM or read only memory. By default, these coefficients are read in a non-sequential order by Tensorflow lite Flatbuffers file. The number of coefficients, however, is often large and therefore can benefit from being stored in larger external or internal flash. Performance on these flash devices are often best achieved when addressing is sequential as data can be continually fetched from the memory without needing to repeat what address is being requested. Since coefficients are stored in ROM, the coefficients can be reorganized in such a way so that the read order can be processed in a sequential order which can reduce the time to read coefficients from the flash memory.

It should be noted that some low cost flash memories such as SPI flash devices can have the data bus held by stopping the clock cycles. For example, an SPI or QSPI flash controller can hold the bus in the middle of a sequential burst which allows for the controller to retain the current burst in progress without needing to reissue a new command, address or hold data in local memory. Retaining burst can improve performance of reading coefficients while reducing the amount of resource needed for the SPI flash controller.

To handle voluminous coefficients, a compression of coefficients can be used to reduce the size of overall flash memory required. A real time decompression decoder can be included within the ROM controller to decode the compressed coefficients. This can improve size required of external ROM as well as read performance, but with the tradeoff of additional resource required in the controller.

COS, in one aspect, includes a semiconductor device able to be selectively programmed for parallel processing logic operations. The semiconductor device includes an input memory such as 502, MCU 506, and ML processor 510. The input memory is used for buffering input signals 504 from an external component such as a camera. MCU 506, in one embodiment, provides a stream of pre-processed data in accordance with input signals 504. ML processor 510 is formed via a first portion of configurable LBs of an FPGA to include a memory controller. The memory controller such as SPI controller includes a local memory to cache a portion of coefficients obtained from a DRAM.

The local memory, in one aspect, is a static RAM (“SRAM”) configured to store addresses for accessing DRAM. The local memory also stores addresses for facilitating DRAM data burst mode. The memory controller is capable of reordering trained machine learning and neural network model coefficients in a sequential addressing order. The memory controller can also facilitate to temporally maintain read addresses for in-progress read operations. The memory controller can also be programmed to facilitate to compress and decompress trained machine learning and neural network model coefficients for conserving storage space

ROM controller 606, in one example, includes an interface 610, decompress block 612, and flash controller 616. While interface 610 is used to communicate with ML processor 510, flash controller 616 handles interface with ROM 608. It should be noted the address between ML processor 510 and controller 606 may not be required as indicated by numeral 620 since the coefficients are reorganized sequentially in an order as to how they will be used.

ROM 608, in one example, stores or loads data that is organized in an order in accordance with how data to be used by ML processor 510. In one embodiment, data stored in ROM 608 is compressed to save ROM size while improving throughput. Bus 622 can be held, by leaving CS low and not issuing clock, for burst reading. The clock cycle resumes when coefficients are needed.

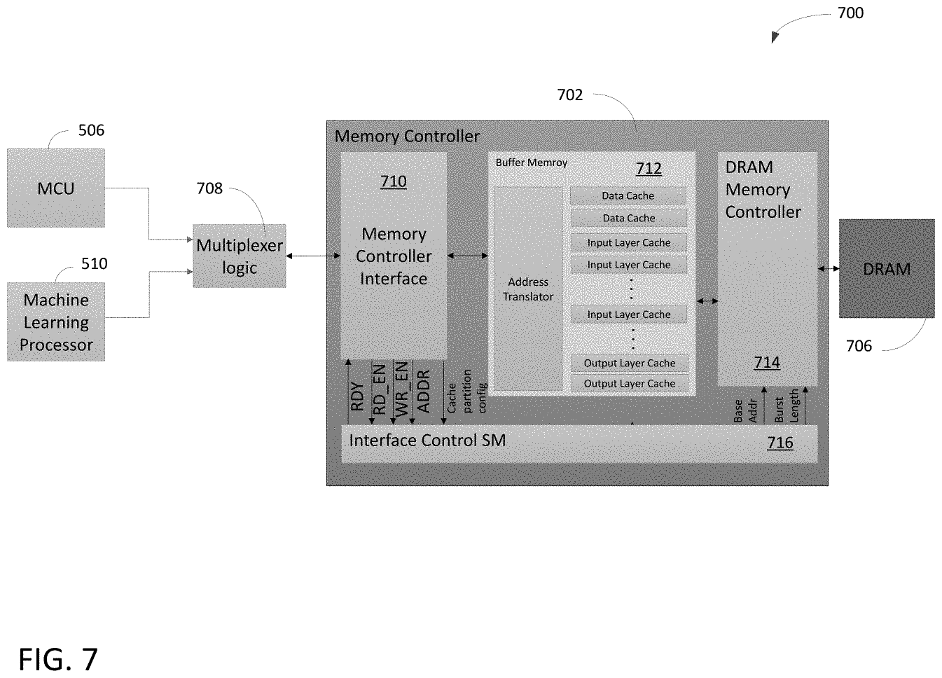

FIG. 7 is a block diagram 700 illustrating a memory controller of COS facilitating data buffering for implementing neural network in accordance with one embodiment of the present invention. Diagram 700 includes MCU 506, ML processor 510, DRAM 706, and memory controller 702 wherein MCU 506 and ML processor 510 are coupled to memory controller 702 via multiplexer logic 708. It should be noted that the underlying concept of the exemplary embodiment(s) of the present invention would not change if one or more blocks (circuit or elements) were added to or removed from diagram 700.

Memory controller 702, in one embodiment, includes an interface 710, buffer memory 712, DRAM controller 714, and interface control SM (system memory) 716. Buffer memory 712, in one aspect, includes multiple data caches, input layer caches, output layer caches, and an address translator. In one example, DRAM memory controller 714 is configured to communicate with DRAM 704. Memory controller 702 is configured to implement data, layer input, and layer output for neural network operations.

Layer memory such as buffer memory 712 holds the input data to be processed by a neural network layer and the output data processed by a neural network layer. These input and output layer memories can often be large. Additionally, there can sometimes be multiple sets of input data or multiple sets of output data to be processed in a single layer.

The ideal layer memory for machine learning models and neural networks would be synchronous, address accessible SRAM. Upon receipt of an address, data associated to the address, for example, is provided immediately or within a small number of clock cycles. MCUs, FPGAs, and/or ASICs have some local SRAM that can provide such a mechanism. It should be noted that SRAM is more expensive than DRAM. As a result, for applications that need a lot of memory, DRAM is favored due to its higher performance, high density, and lower gate count (cost). The tradeoff is that DRAM such as DDR (Double Data Rate) SDRAM, PSRAM/HyperRAM require the controller to issue a command and address and then wait for a significant number of clock cycles before the memory returns data. DRAM appears to be an efficient when addresses can be sequential where one base address can be issued and data at sequentially read out there after.

Depending on the applications, machine learning models often favor a non-sequential address approach since data from the input layer will need to be read at several different address offsets to calculate the layer data output. In this case, local buffer memory caching multiple address offsets would have an initial read time penalty, but later would offer the same performance as SRAM since multiple address offsets would be locally stored. The SRAM used for the local buffer memory could be significantly smaller than what would be required to process the layer in its entirety, but dramatically improve performance over reading one DRAM address at a time.

Layers with multiple inputs and outputs also benefit from a memory controller which offers multiple address caching since these multiple inputs and outputs are located at different addresses themselves. Layers with sequential addressing (such as standard convolutions) include a larger number of inputs at a time for calculating one output. Layer computation tends to use the same address space repeatedly with different coefficients for calculating each layer output.

In this case, the memory controller such as memory controller 702 with local buffer memory caching of multiple address offsets can provide benefit. Each cache is loaded with the next sequential address. If the memory controller knows that multiple caches will be loaded with sequential addresses it can take the advantage of load the caches with a longer burst of external DRAM. Addresses can then be read sequentially across multiple caches multiple times without needing additional DRAM accesses. Additionally, buffer memory in the memory controller which is designed with the ability to cache multiple addresses can offer allocation for the instruction and data memory of the control MCU or state machine described earlier. This allows the control MCU and machine learning processor to leverage the same large DRAM with minimal performance impact.

FPGA Overview

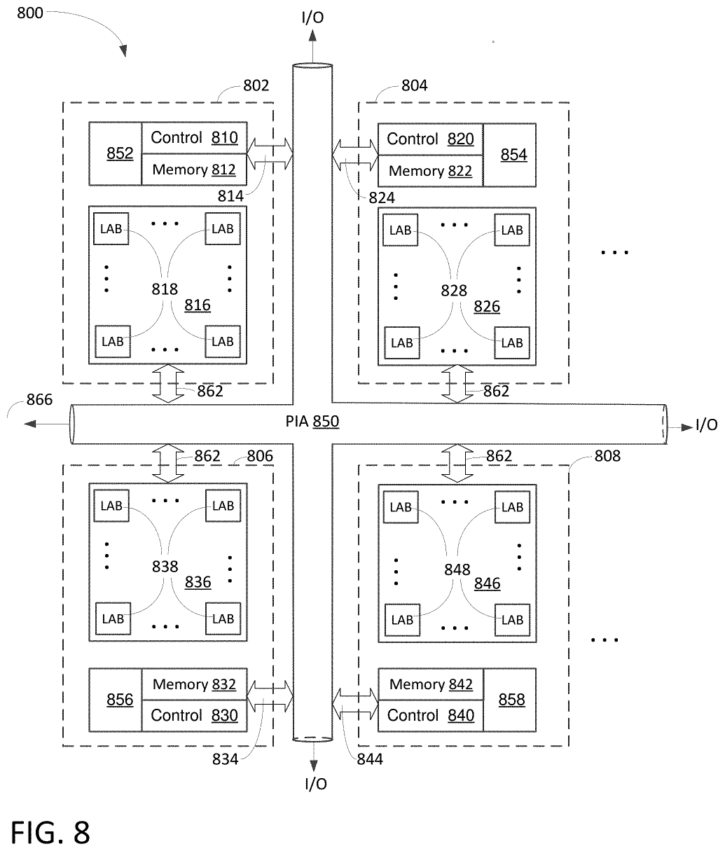

FIG. 8 is a diagram 800 illustrating an FPGA capable of facilitating COS for handling neural network operations in accordance with one embodiment of the present invention. Diagram 800 includes multiple programmable partitioned regions (“PPR”) 802-808, a programmable interconnection array (“PIA”) 850, internal power distribution fabric, and regional input/output (“I/O”) ports 866. PPRs 802-808 further includes control units 810, 820, 830, 840, memories 812, 822, 832, 842, configurable COS blocks 852-858, and logic blocks (“LBs”) 816, 826, 836, 846. Note that control units 810, 820, 830, 840 can be configured into one single control unit, and similarly, memory 812, 822, 832, 843 can also be configured into one single memory device for storing configurations. Furthermore, configurable COS blocks 852-858 can also be to combined into one single programmable COS block. It should be noted that the underlying concept of the exemplary embodiment(s) of the present invention would not change if one or more blocks (circuit or elements) were added to or removed from diagram 800.

LBs 816, 826, 836, 846, include multiple LABs 818, 828, 838, 848, wherein each LAB can be further organized to include, among other circuits, a set of programmable logical elements (“LEs”) or macrocells, not shown in FIG. 8. Each LAB, in one example, may include anywhere from 32 to 512 programmable LEs. I/O pins (not shown in FIG. 8), LABs, and LEs are linked by PIA 850 and/or other buses, such as buses 862, 814, 824, 834, 844, for facilitating communication between PIA 850 and PPRs 802-808.

Each LE includes programmable circuits such as the product-term matrix, and registers. For example, every LE can be independently configured to perform sequential and/or combinatorial logic operation(s). It should be noted that the underlying concept of PSD would not change if one or more blocks and/or circuits were added or removed from PSD.

Control units 810, 820, 830, 840, also known as configuration logics, can be a single control unit. Control unit 810, for instance, manages and/or configures individual LE in LAB 818 based on the configuration stored in memory 812. It should be noted that some I/O ports or I/O pins are configurable so that they can be configured as input pins and/or output pins. Some I/O pins are programmed as bi-directional I/O pins while other I/O pins are programmed as unidirectional I/O pins. The control units such as unit 810 is used to handle and/or manage PSD operations in accordance with system clock signals.

LBs 816, 826, 836, 846 are programmable by the end user(s). Depending on the applications, LBs can be configured to perform user specific functions based on a predefined functional library facilitated by configuration software. PSD, in some applications, also includes a set fixed circuits for performing specific functions. For example, PSD can include a portion of semiconductor area for a fixed non-programmable processor for enhance computation power.

PIA 850 is coupled to LBs 816, 826, 836, 846 via various internal buses such as buses 814, 824, 834, 844, 862. In some embodiments, buses 814, 824, 834, 844, and 862 are part of PIA 850. Each bus includes channels or wires for transmitting signals. It should be noted that the terms channel, routing channel, wire, bus, connection, and interconnection are referred to the same or similar connections and will be used interchangeably herein. PIA 850 can also be used to receives and/or transmits data directly or indirectly from/to other devices via I/O pins and LAB s.

A function of COS block such as COS block 852 is a special purpose block capable of facilitating establishing an accelerator or ML processor for performing offloading operation. An advantage of employing a programmable COS block is to enhance efficiency of processing ML operation for a neural network.

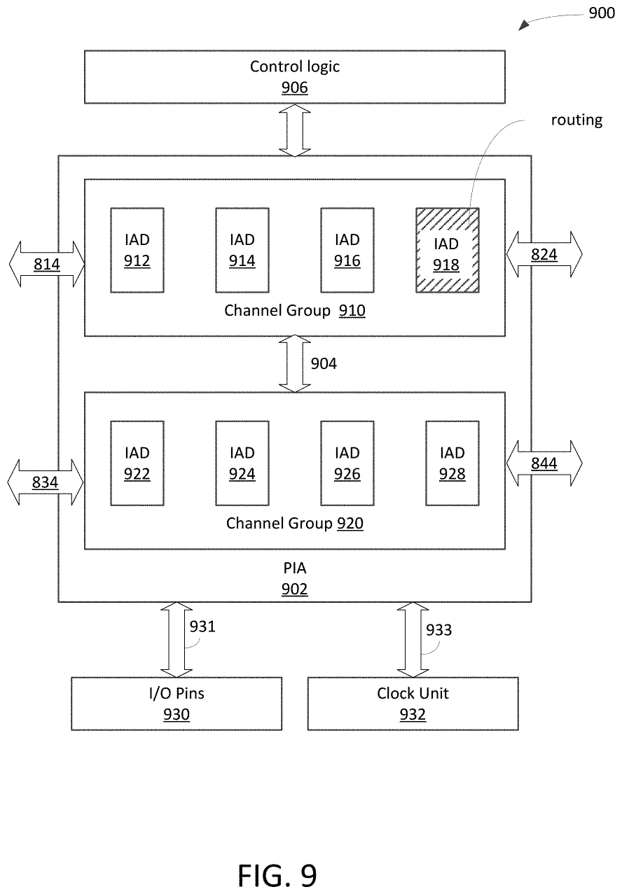

FIG. 9 is a diagram 900 illustrating a routing logic or fabric containing programmable arrays for facilitating interconnecting various components including COS block routing in accordance with one embodiment of the present invention. Diagram 900 includes control logic 906, PIA 902, I/O pins 930, and clock unit 932. Control logic 906, which may be similar to control units shown in FIG. 8, provides various control functions including channel assignment, differential I/O standards, and clock management. Control logic 906 may contain volatile memory, non-volatile memory, and/or a combination of volatile and nonvolatile memory device for storing information such as configuration data. In one embodiment, control logic 906 is incorporated into PIA 902. It should be noted that the underlying concept of the exemplary embodiment(s) of the present invention would not change if one or more blocks (circuit or elements) were added to or removed from diagram 900.

I/O pins 930, connected to PIA 902 via a bus 931, contain multiple programmable I/O pins configured to receive and/or transmit signals to external devices. Each programmable I/O pin, for instance, can be configured to input, output, and/or bi-directional pin. Depending on the applications, I/O pins 930 may be incorporated into control logic 906.

Clock unit 932, in one example, connected to PIA 902 via a bus 933, receives various clock signals from other components, such as a clock tree circuit or a global clock oscillator. Clock unit 932, in one instance, generates clock signals in response to system clocks as well as reference clocks for implementing I/O communications. Depending on the applications, clock unit 932, for example, provides clock signals to PIA 902 including reference clock(s).

PIA 902, in one aspect, is organized into an array scheme including channel groups 910 and 920, bus 904, and I/O buses 814, 824, 834, 844. Channel groups 910, 920 are used to facilitate routing information between LBs based on PIA configurations. Channel groups can also communicate with each other via internal buses or connections such as bus 904. Channel group 910 further includes interconnect array decoders (“IADs”) 912-918. Channel group 920 includes four IADs 922-928. A function of IAD is to provide a configurable routing resources for data transmission.

IAD such as IAD 912 includes routing multiplexers or selectors for routing signals between I/O pins, feedback outputs, and/or LAB inputs to reach their destinations. For example, an IAD can include up to 36 multiplexers which can be laid out in four banks wherein each bank contains nine rows of multiplexers. It should be noted that the number of IADs within each channel group is a function of the number of LEs within the LAB.

PIA 902, in one embodiment, designates a special IAD such as IAD 918 for handling COS block routing. For example, IAD 918 is designated to handle connections and/or routings between COS block and the LABs to facilitate neural network operation. It should be noted that additional IADs may be allocated for handling COS block operations.

An advantage of using IAD 918 within PIA as a designated COS block routing is that it integrates COS block with FPGA to provide efficient neural network operation.

The exemplary embodiment of the present invention includes various processing steps, which will be described below. The steps of the embodiment may be embodied in machine or computer-executable instructions. The instructions can be used to cause a general-purpose or special-purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

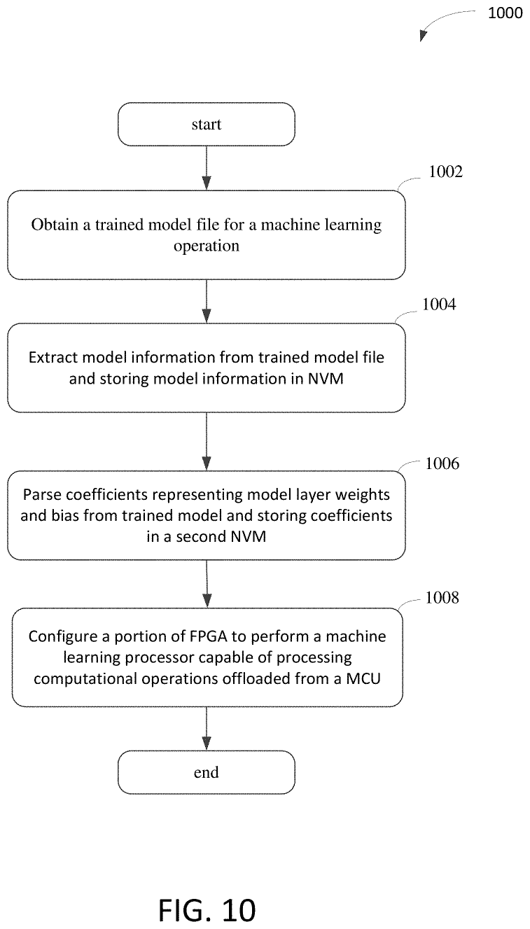

FIG. 10 is a flowchart 1000 illustrating a process of COS using FPGA in accordance with one embodiment of the present invention. At block 1002, a process for processing data via a dedicated neural network processor obtains a trained model file for a machine learning operation. For example, the obtaining a trained model file includes extracting model information from Flatbuffers™ or Tensorflow™.

At block 1004, the model information from the trained model file is extracted. The model information is subsequently stored in an onboard first nonvolatile memory (“NVM”) in FPGA.

At block 1006, the coefficients representing model layer weights and bias is parsed from the trained model and storing the coefficients in a second NVM in the FPGA.

At block 1008, configuring a portion of the FPGA is configured to behave as an accelerator or a machine learning processor for performing and/or processing computational operations offloaded from MCU. In one example, upon retrieving one or more model information from for the first NVM to the MCU, the model information is forwarded to layer register map in FPGA. After retrieving the model information from the layer register map, the machine learning processor facilitates a machine learning process or neural network operations in accordance with the model information and the coefficients from the second NVM. In one example, a first block or first portion of configurable LBs of FPGA is programmed to perform functions of the machine learning processor for facilitating offloading computational tasks. In another example, a second block or second portion of configurable LBs of FPGA is capable of performing functions of MCU for offloading computational tasks to one or more secondary computing units such as accelerators.

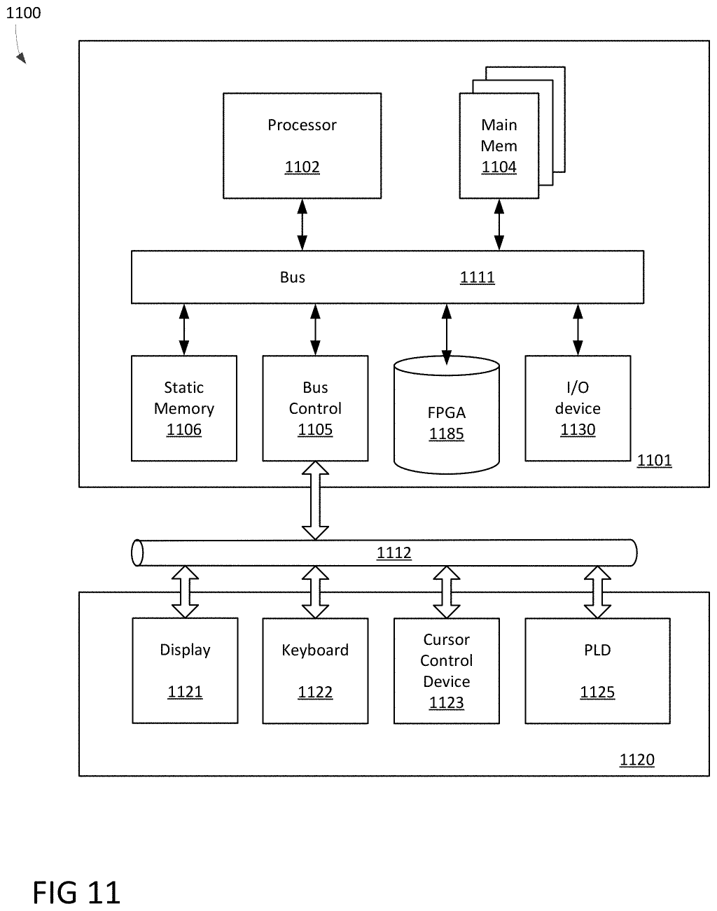

FIG. 11 is a diagram 1100 illustrating a digital processing system and a cloud-based system environment using one or more COSs in accordance with one embodiment of the present invention. Computer system 1100 includes a processing unit 1101, an interface bus 1112, and an input/output (“TO”) unit 1120. Processing unit 1101 includes a processor 1102, main memory 1104, system bus 1111, static memory device 1106, bus control unit 1105, I/O element 1130, and FPGA 1185. It should be noted that the underlying concept of the exemplary embodiment(s) of the present invention would not change if one or more blocks (circuit or elements) were added to or removed from FIG. 11.

Bus 1111 is used to transmit information between various components and processor 1102 for data processing. Processor 1102 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, Ryzen™, AMD® family processors, or Power PC™ microprocessor.

Main memory 1104, which may include multiple levels of cache memories, stores frequently used data and instructions. Main memory 1104 may be RAM (random access memory), MRAM (magnetic RAM), or flash memory. Static memory 1106 may be a ROM (read-only memory), which is coupled to bus 1111, for storing static information and/or instructions. Bus control unit 1105 is coupled to buses 1111-1112 and controls which component, such as main memory 1104 or processor 1102, can use the bus. Bus control unit 1105 manages the communications between bus 1111 and bus 1112. Mass storage memory or SSD which may be a magnetic disk, an optical disk, hard disk drive, floppy disk, CD-ROM, and/or flash memories are used for storing large amounts of data.

I/O unit 1120, in one embodiment, includes a display 1121, keyboard 1122, cursor control device 1123, and PLD 1125. Display device 1121 may be a liquid crystal device, cathode ray tube (“CRT”), touch-screen display, or other suitable display device. Display 1121 projects or displays images of a graphical planning board. Keyboard 1122 may be a conventional alphanumeric input device for communicating information between computer system 1100 and computer operator(s). Another type of user input device is cursor control device 1123, such as a conventional mouse, touch mouse, trackball, or other type of cursor for communicating information between system 1100 and user(s).

PLD 1125 is coupled to bus 1112 for providing configurable logic functions to local as well as remote computers or servers through wide-area network. PLD 1125 and/or FPGA 1185 includes one or more COSs for facilitating implementation of offloaded neural network operations. In one example, PLD 1125 may be used in a modem or a network interface device for facilitating communication between computer 1100 and the network. Computer system 1100 may be coupled to a number of servers via a network infrastructure as illustrated in the following discussion.

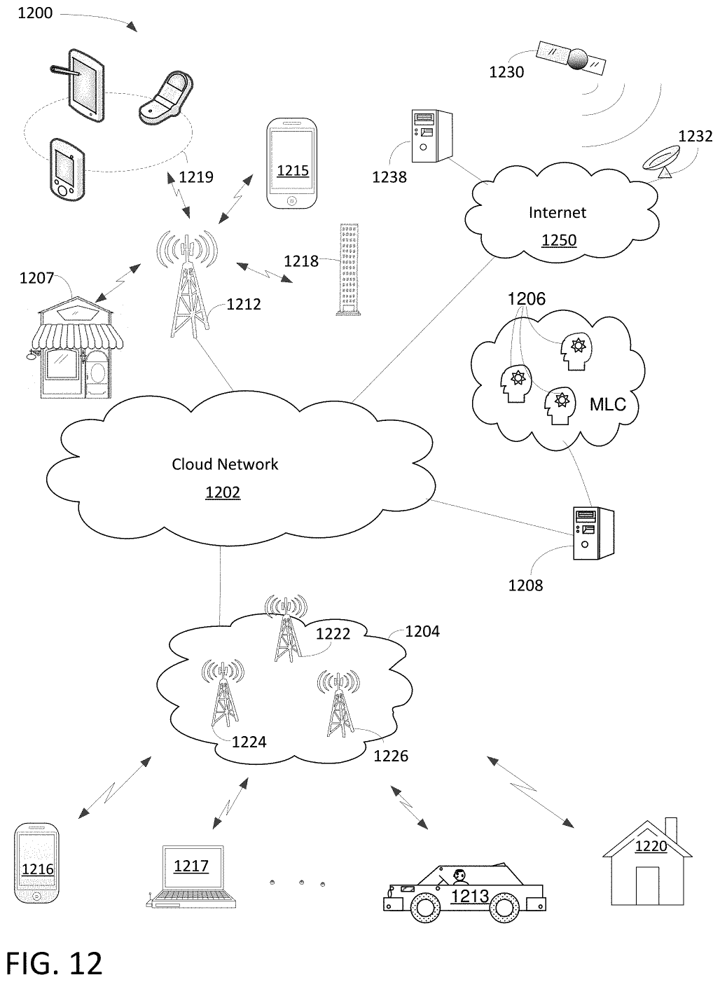

FIG. 12 is a diagram 1200 illustrating a cloud-based system environment using one or more COSs in accordance with one embodiment of the present invention. Diagram 1200 illustrates AI server 1208, communication network 1202, switching network 1204, Internet 1250, and portable electric devices 1213-1219. In one aspect, COS can be used in AI server, portable electric devices, and/or switching network. Network or cloud network 1202 can be wide area network (“WAN”), metropolitan area network (“MAN”), local area network (“LAN”), satellite/terrestrial network, or a combination of WAN, MAN, and LAN. It should be noted that the underlying concept of the exemplary embodiment(s) of the present invention would not change if one or more blocks (or networks) were added to or removed from diagram 1200.

Network 1202 includes multiple network nodes, not shown in FIG. 12, wherein each node may include mobility management entity (“MME”), radio network controller (“RNC”), serving gateway (“S-GW”), packet data network gateway (“P-GW”), or Home Agent to provide various network functions. Network 1202 is coupled to Internet 1250, AI server 1208, base station 1212, and switching network 1204. Server 1208, in one embodiment, includes machine learning computers (“MLC”) 1206.

Switching network 1204, which can be referred to as packet core network, includes cell sites 1222-1226 capable of providing radio access communication, such as 3G (3^{rd} generation), 4G, or 5G cellular networks. Switching network 1204, in one example, includes IP and/or Multiprotocol Label Switching (“MPLS”) based network capable of operating at a layer of Open Systems Interconnection Basic Reference Model (“OSI model”) for information transfer between clients and network servers. In one embodiment, switching network 1204 is logically coupling multiple users and/or mobiles 1216-1220 across a geographic area via cellular and/or wireless networks. It should be noted that the geographic area may refer to a campus, city, metropolitan area, country, continent, or the like.

Base station 1212, also known as cell site, node B, or eNodeB, includes a radio tower capable of coupling to various user equipments (“UEs”) and/or electrical user equipments (“EUEs”). The term UEs and EUEs are referring to the similar portable devices and they can be used interchangeably. For example, UEs or PEDs can be cellular phone 1215, laptop computer 1217, iPhone® 1216, tablets and/or iPad® 1219 via wireless communications. Handheld device can also be a smartphone, such as iPhone®, BlackBerry®, Android®, and so on. Base station 1212, in one example, facilitates network communication between mobile devices such as portable handheld device 1215 or 1219 via wired and/or wireless communications networks. It should be noted that base station 1212 may include additional radio towers as well as other land switching circuitry.

Internet 1250 is a computing network using Transmission Control Protocol/Internet Protocol (“TCP/IP”) to provide linkage between geographically separated devices for communication. Internet 1250, in one example, couples to supplier server 1238 and satellite network 1230 via satellite receiver 1232. Satellite network 1230, in one example, can provide many functions as wireless communication as well as global positioning system (“GPS”). It should be noted that WAP can be applied to many fields, such as, but not limited to, smartphones 1215-1216, satellite network 1230, automobiles 1213, AI server 1208, business 1207, and homes 1220.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A semiconductor device able to be selectively programmed for parallel processing logic operations, comprising:
an input memory for buffering a stream of input signals from an external component before being processed;
a processing unit, coupled to the input memory, configured to retrieve the stream of input signals from the input memory and generating pre-processed data in accordance with the stream of input signals; and
a first circuit, containing a plurality of configurable logic blocks (“LBs”) able to be selectively programmed to perform one or more neural networking functions, configured to process a first set of convolutional operation in response to at least a portion of the pre-processed data offloaded from the processing unit.

2. The semiconductor device of claim 1, further comprising a second circuit, containing a plurality of configurable LBs programmed to perform one or more neural networking functions, configured to process a second set of convolutional operation in response to at least a portion of the pre-processed data offloaded from the processing unit.

3. The semiconductor device of claim 1, wherein the input memory is a group of memory cells onboard of a field programmable gate arrays (“FPGA”).

4. The semiconductor device of claim 1, wherein the external component is one of an optical sensor and microphone.

5. The semiconductor device of claim 1, wherein the processing unit is a hardcore processor fabricated on a field programmable gate arrays (“FPGA”).

6. The semiconductor device of claim 1, wherein the processing unit is a softcore processor programmed within configurable LBs in a field programmable gate arrays (“FPGA”).

7. The semiconductor device of claim 1, wherein the pre-processed data is spectrogram containing audio or video information.

8. The semiconductor device of claim 1, wherein the first circuit is a visual accelerator configured to generate visual reference based on spectrogram containing visual images.

9. The semiconductor device of claim 2, wherein the second circuit is an audio accelerator configured to generate audio reference based on spectrogram containing sound.

10. The semiconductor device of claim 1, wherein capacity of the input memory determines size of input in a neural network operation.

11. The semiconductor device of claim 1, further comprising processor memory wherein capacity of the processor memory determines number of layers in a neural network operation.

12. The semiconductor device of claim 1, further comprising pseudo static random-access memory (“PSRAM”) wherein capacity of the PSRAM determines layer width in a neural network operation.

13. A field programmable gate arrays (“FPGA”) capable of being configured to parallel process data for one or more neural network operation comprising the semiconductor device of claim 1.

14. A method for processing data via a dedicated neural network processor, comprising:
obtaining a trained model file for a machine learning operation;
extracting model information from the trained model file and storing the model information in an onboard first nonvolatile memory (“NVM”) in a field programmable gate arrays (“FPGA”);
parsing coefficients representing model layer weights and bias from the trained model and storing the coefficients in a second NVM in the FPGA; and
configuring a portion of the FPGA to be a machine learning processor capable of processing computational operations offloaded from a microcontroller (“MCU”).

15. The method of claim 14, further comprising:
retrieving one or more model information from for the first NVM to the MCU; and
forwarding the model information to layer register map in the FPGA.

16. The method of claim 15, further comprising:
retrieving the model information from the layer register map to the machine learning processor; and
performing machine learning process in accordance with the model information and the coefficients from the second NVM.

17. The method of claim 14, wherein obtaining a trained model file includes extracting model information from Flatbuffers™ of Tensorflow™.

18. The method of claim 14, further comprising programming a first portion of configurable logic blocks (“LBs”) of the FPGA to perform functions of the machine learning processor for facilitating offloading computational tasks.

19. The method of claim 18, further comprising programming a second portion of configurable LBs of the FPGA to perform functions of the MCU for offloading computational tasks to one or more secondary computing units.

20. A semiconductor device able to be selectively programmed for parallel processing logic operations, comprising:
an input memory for buffering input signals from an external component;
a microcontroller (“MCU”) configured to provide a stream of pre-processed data in accordance with the input signals; and
a first portion of configurable logic blocks (“LBs”) of a field programmable gate arrays (“FPGA”), coupled to the MCU, configured to be programmed to behave as a machine learning processor containing a memory controller, wherein the memory controller includes a local memory to cache a portion of coefficients obtained from a dynamic random-access memory (“DRAM”).

21. The device of claim 20, wherein the local memory is a static RAM (“SRAM”) configured to store addresses for accessing DRAM.

22. The device of claim 20, wherein the local memory stores addresses for facilitating DRAM data burst mode.

23. The device of claim 20, wherein the memory controller is configured to reorder trained machine learning and neural network model coefficients in a sequential addressing order.

24. The device of claim 20, wherein the memory controller facilitates to temporally maintain read addresses for in-progress read operations.

25. The device of claim 20, wherein the memory controller facilitates to compress and decompress trained machine learning and neural network model coefficients for conserving storage space.
